(19) United States
(12) Patent Application Publication
(10) Pub. No.: US 2025/0162686 A1
(43) Pub. Date: May 22, 2025

(54) ELECTRIC BICYCLE BATTERY WITH ACTIVATION SENSOR, ELECTRIC BICYCLE WITH SUCH AN ELECTRIC BICYCLE BATTERY AND METHOD FOR OPERATING AN ELECTRIC BICYCLE BATTERY

(71) Applicant: PORSCHE EBIKE PERFORMANCE GMBH, Ottobrunn (DE)

(72) Inventors: Oskar KAUFMANN, München (DE); Johannes BIECHELE, Riedering (DE)

(21) Appl. No.: 18/835,621

(22) PCT Filed: Feb. 2, 2023
(86) PCT No.: PCT/EP2023/052589

§ 371 Date: Aug. 2, 2024

(30) Foreign Application Priority Data
Feb. 3, 2022 (DE) 10 2022 102 599.3

(51) Int. Cl. B62M 6/90

(52) U.S. Cl. CPC B62M 6/90

(57) ABSTRACT

An electric bicycle battery having a housing and at least one battery cell arranged within the housing, wherein at least one activation sensor is arranged within the housing for detecting an activation action. An electric bicycle having an electric bicycle battery, and to-a method for operating an electric bicycle battery are also related.

### CROSS-REFERENCE TO RELATED APPLICATIONS

This application is a 35 U.S.C. § 371 National Stage patent application of PCT/EP2023/052589 filed 2 Feb. 2023, which claims the benefit of German patent application 10 2022 102 599.3 filed 3 Feb. 2022, the disclosures of which are incorporated herein by reference in their entirety.

### TECHNICAL FIELD

The disclosure relates to an electric bicycle battery according to the claims. The disclosure further relates to an electric bicycle with such an electric bicycle battery, and to a method for the operation of an electric bicycle battery according to the claims.

### BACKGROUND

Electric bicycle batteries (hereinafter also referred to simply as batteries) for the supply of energy to drive units for electric bicycles are well known from the prior art. When installed on the bicycle, these batteries can usually be controlled via an operating unit. The operating unit is positioned on the handlebars, for example, and is connected to the battery. The operating unit can be used, amongst other functions, to interrogate and visualise the battery's state of charge or any fault messages.

To enable communication with the battery in the disassembled state, it is of known art, amongst other features, to equip the battery with a button or push-button. By means of the push-button, the battery can be switched on even in the disassembled state, when detached from the bicycle, and can display its state of charge or any fault messages by way of LEDs, for example.

The use of a push-button requires at least one electrical passage through the housing. Such a passage is also a potential entry point for moisture. In addition, the housing must be designed in such a way that there is sufficient space for the attachment of a foil into which the push button is integrated, and which also has an adhesive edge for the cable passage. In addition, the connector, which is arranged on the circuit board and serves to make contact with the push-button, requires a comparatively large amount of installation space. The arrangement of the push-button contacts also determines the arrangement of the circuit board within the housing.

### SUMMARY

The present disclosure provides an electric bicycle battery for a bicycle, an electric bicycle and a method for the operation of an electric bicycle battery, by means of which it is possible to operate the electric bicycle battery in the disassembled state in the simplest possible manner.

In accordance with the disclosure, this is achieved by providing the features of the independent claims. Further forms of embodiment and advantages are described in the context of the dependent claims.

An electric bicycle battery in accordance with the disclosure has a housing and at least one battery cell arranged within the housing. The housing surrounds the at least one battery cell, in particular on all sides, and serves to protect the at least one battery cell. In particular, the electric bicycle battery has a plurality of battery cells, and preferably 24 battery cells, each of 3.6 V rating. In particular, the battery cells are connected in such a way that 12 battery cells are in each case arranged in series in two parallel sets. In particular, the battery cells are of cylindrical design. In particular, the electric bicycle battery takes the form of a battery with a supply voltage in the low-voltage range. In particular, the rated voltage of the electric bicycle battery lies below 60 V and is preferably 43 V.

At least one activation sensor is also arranged within the housing of the battery for purposes of detecting an activation operation. In the context of the disclosure, an activation operation is an operation that serves to “wake up” or activate the battery that is in a state in which it is detached from the bicycle. In particular, the battery, in this state in which it is detached from the bicycle, is in a “deep-sleep mode”, in which the battery consumes no, or hardly any, energy. Concrete activation operations-also described in more detail hereinafter-can comprise the rotating, pivoting, or shaking, of the battery, or a specific contact with, illumination of, or heating of the housing. The particular activation operation is detected by way of the activation sensor provided for this purpose. After the battery has been “awakened” or activated, it can display a current state of charge and/or a fault code. For this purpose, the battery has, in particular, a display unit, such as a plurality of LEDs.

The advantage of an electric bicycle battery in accordance with the disclosure is that the activation sensor is only arranged within the housing. No passages through the housing are required. The electric bicycle battery does not have any push-buttons. In addition, the freedom of design for the arrangement of the at least one battery cell in the housing, of a control unit or circuit board within the housing, as well as for the housing itself is considerably improved by the omission of the push-button. Nevertheless, the battery can be activated in a state in which it is detached from the bicycle, and it is also possible to communicate with the battery in a “stand alone” manner, that is to say, without an external operating unit.

In particular, the activation sensor is arranged on a circuit board arranged in the housing. In particular, the activation sensor is arranged on the circuit board for the battery management system.

In a practical form of embodiment of the electric bicycle battery in accordance with the disclosure, the activation sensor comprises at least one acceleration sensor. By means of the acceleration sensor, a movement of the battery can be detected and recognised as an activation operation. Such an activation operation that is to be detected by means of an acceleration sensor is, for example, the movement of the battery, in particular along a defined trajectory. An activation operation can, at the same time, be the rotation of the battery through 45° about its own axis. Alternatively, the activation operation can also be a shaking movement, or another rotation, or a combination of a rotation and a lateral movement. The activation sensor comprises, in particular, a plurality of acceleration sensors, which detect the acceleration in all three spatial axes. In particular, the acceleration sensor used here is a piezoelectric acceleration sensor or a microelectromechanical system (MEMS). Such an acceleration sensor requires particularly little installation space.

In particular, three acceleration sensors, in each case aligned orthogonally to one another, can be combined into a so-called IMU (inertial measurement unit). From the measured data of the IMU detected by the acceleration sensors, after compensation for the acceleration due to gravity, the linear speed can be determined by integration, and, by further integration, the position of the respective IMU can be determined relative to a reference point. In addition, three rate of rotation sensors can be provided. The integration of the three angular velocities determined by the rate of rotation sensors delivers the orientation of the IMU (the tilt) relative to a reference point.

Alternatively or additionally, the activation sensor can comprise an inductive sensor. An inductive sensor detects when a body part, such as a finger, approaches the activation sensor outside the housing. In particular, a fingerprint scanner can be used here, which additionally increases the security of the electric bicycle battery against theft.

The activation sensor can also take the form of a light-sensitive sensor that reacts to illumination or shading.

An acoustic sensor is also conceivable, wherein, for example, a certain sound, such as a clap, or a certain word, is detected, which leads to the awakening of the electric bicycle battery.

In a further practical form of embodiment of the electric bicycle battery in accordance with the disclosure, the activation sensor is connected to the at least one battery cell and is supplied with energy by way of the latter. The activation sensor then requires no additional energy supply.

The electric bicycle battery has at least two modes of operation, wherein a first mode of operation is a deep-sleep mode, and wherein a second mode of operation is a quiescent mode. The battery enters the deep-sleep mode if the battery is detached from the bicycle and is not connected to an operating unit and/or a power supply. In the deep-sleep mode, the battery consumes only minimal energy to power its components. The quiescent mode (also referred to as idle-SoC) is a mode that is present after the battery has been awakened by an activation operation, and wherein, for example, the state of charge, or a fault code, is displayed for a defined time interval.

In addition, the electric bicycle battery may have a third mode of operation, which is a shipping mode. The shipping mode can be activated for the transport of the battery. The shipping mode is characterised by the fact that an activation, that is to say an awakening from the shipping mode, is only possible by connecting an external operating unit and/or an external power supply. In particular, the activation sensor is deactivated during the shipping mode. The shipping mode is intended to prevent any vibrations, rotations, or handling of the battery that occur during transport, or are caused by transport, from leading to an awakening of the battery and the consumption of additional energy.

The disclosure also relates to an electric bicycle with an electric bicycle battery as described above. An electric bicycle (also referred to as an e-bicycle or a pedelec) has a drive unit for providing assistance when pedalling. The drive unit is supplied with energy from the electric bicycle battery. As described above, the battery can be detached from the electric bicycle and can exist as a separate battery. In this state, the battery then enters a deep-sleep mode.

The disclosure further relates to a method for operating an electric bicycle battery, in particular an electric bicycle battery as described above. “Operating” here means activation of the battery, deactivation of the battery, the movement into, and the awakening from, a deep-sleep mode, or possibly other modes, as well as a reading of a state-of-charge indicator and/or a fault code.

For this purpose, the electric bicycle battery is in a disassembled state, wherein the battery is detached from a bicycle and has no contact with an operating unit and/or an external power supply. The battery is in a deep-sleep mode (first operating mode) and an activation operation is detected by means of at least one activation sensor, and, triggered by the activation operation, the electric bicycle battery is switched into a second operating mode, in which the electric bicycle battery displays a state of charge and/or a fault code. For this purpose, the electric bicycle battery in particular has various light sources.

As already described above, an activation operation detected by the activation sensor can cause activation even in the disassembled state. The advantages of such an activation sensor arranged only within the housing have already been described above.

In particular, the activation operation takes the form of a movement of the electric bicycle battery. In particular, the battery is moved along a defined trajectory. The movement of the battery is detected by the activation sensor. A trajectory can, for example, be a rotation of the battery through 45° about one of its axes. For activation, a rotation about a specific axis of the battery can be defined, or an activation can also take place when if there is a rotation about one of the three spatial axes.

As also described above, the activation operation can take the form of contact with a certain activation region. The activation can then be detected in particular by way of induction. The activation operation can alternatively or additionally be the emission of an acoustic signal and/or an optical signal.

In a practical form of embodiment of the method in accordance with the disclosure, the electric bicycle battery displays the state of charge and/or the fault code for a defined period of time (in particular in the quiescent mode or idle-SoC) and is subsequently moved back into the first operating mode, the deep-sleep mode. The defined time period in particular takes the form of a few seconds or a few minutes. In particular, the state of charge and/or a fault code can be displayed for a period of between 10 s and 30 s. The transition into the first operating mode takes place automatically.

In addition, the electric bicycle battery may have a further operating mode in the form of a shipping mode, and the electric bicycle battery is only moved out of this operating mode by way of a connection to an external power supply and/or an operating unit and/or by introduction into the electric bicycle. The shipping mode cannot be terminated by the activation operations described above.

### BRIEF DESCRIPTION OF THE DRAWINGS

Further practical forms of embodiment and advantages are described below in conjunction with the figures. Here:

FIG. 1 shows a schematic representation of an electric bicycle battery, and

FIG. 2 shows a flowchart for the awakening of an electric bicycle battery.

### DETAILED DESCRIPTION OF THE DRAWINGS

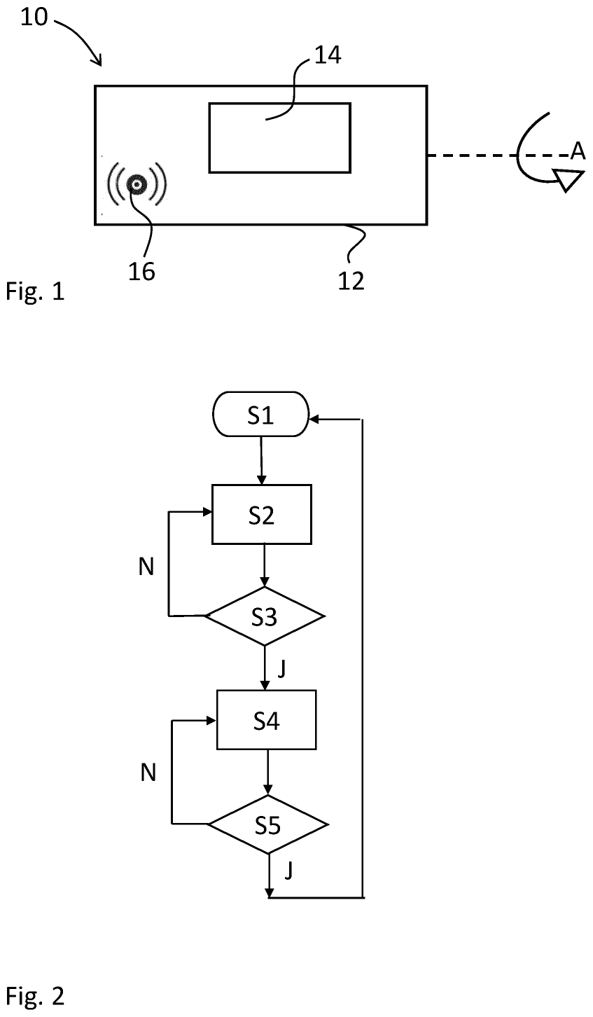

In FIG. 1, an electric bicycle battery 10 is illustrated schematically. The electric bicycle battery comprises a housing 12 in which at least one battery cell 14 is arranged. Furthermore, an activation sensor 16, for the detection of an activation operation, is arranged within the housing 12.

In the present case, the activation sensor 16 comprises a plurality of acceleration sensors, which detect an acceleration of the battery 10 in all three spatial directions.

The battery 10 is provided in a detached state from an electric bicycle and is connected neither to an operating unit nor to an external power supply. The battery 10 is in a first operating mode: a deep-sleep mode. For the awakening of the battery 10 from the deep-sleep mode, the form of embodiment shown here is rotated through at least 45° about an axis A by an activation operation. This rotation is detected by the activation sensor 16, and the battery is awakened. Here a rotation about the longitudinal axis is shown as an example. However, it is also conceivable that rotations about the vertical axis or transverse axis lead to an activation of the battery 10.

In what follows, the method for the operation of such a battery 10 is explained in conjunction with FIG. 2.

In step S1, it is determined in the first instance that the battery 10 has no contact with an operating unit or an external power supply, and in step S2 the battery 10 is moved into a deep-sleep mode.

If in step S3 an activation operation is identified (J) by the activation sensor 16, for example a rotation of the battery 10 as described in conjunction with FIG. 1 (or also by way of an inductive identification of the approach of a body part or of a visual or acoustic signal), in step S4 the battery 10 indicates a state of charge. The battery 10 is then in a second operating state, a quiescent mode.

If in step S3 no activation operation is detected (N), the battery 10 remains in the deep-sleep mode.

If in step S5 it is determined that the battery 10 has already been in the quiescent mode for a defined time interval (J), the battery 10 is automatically moved back into the deep-sleep mode.

1. An electric bicycle battery with a housing and at least one battery cell arranged within the housing,
wherein
at least one activation sensor for the detection of an activation operation is arranged within the housing.

2. The electric bicycle battery according to claim 1,
wherein the activation sensor comprises at least one acceleration sensor.

3. The eElectric bicycle battery according to claim 1,
wherein_the activation sensor comprises an inductive sensor, a light-sensitive sensor, and/or an acoustic sensor.

4. The electric bicycle battery according to claim 1,
wherein the activation sensor is connected to the at least one battery cell and is supplied with energy by way of the battery cell.

5. The electric bicycle battery according to claim 1,
wherein the electric bicycle battery has at least two operating modes, wherein a first operating mode is a deep-sleep mode, and wherein a second operating mode is a quiescent mode.

6. The electric bicycle battery according to claim 5,
wherein the electric bicycle battery has a third operating mode, which is a shipping mode.

7. The electric bicycle with an electric bicycle battery according to claim 1.

8. A method for operating an electric bicycle battery, the method including the following steps:
providing the electric bicycle battery in a disassembled state and a first operating mode,
detecting an activation operation using at least one activation sensor, and
switching the electric bicycle battery triggered by the activation operation, into a second operating mode, whereby the electric bicycle battery displays a state of charge and/or a fault code.

9. The method according to claim 8,
wherein the activation operation is a movement of the electric bicycle battery.

10. The method according to claim 8,
wherein the activation operation comprises a contact with a specific activation region, an emission of an acoustic signal, and/or the emission of an optical signal.

11. The method according to claim 8,
wherein the electric bicycle battery displays the state of charge and/or the fault code for a defined period of time, and is subsequently moved back into the deep-sleep mode.

12. The method according to claim 8,
wherein the electric bicycle battery has a further operating mode in the form of a shipping mode, and the electric bicycle battery is moved out of this operating mode by way of a connection to an external power supply and/or an operating unit and/or by an introduction into the electric bicycle.
